(19) United States
(12) Patent Application Publication
(10) Pub. No.: US 2005/0231578 A1
(43) Pub. Date: Oct. 20, 2005

(54) Image forming apparatus

(76) Inventor: Koki Tajima, Kobe-shi (JP)

Correspondence Address: HARNESS, DICKEY & PIERCE, P.L.C., P.O. BOX 828, BLOOMFIELD HILLS, MI, 48303, US

(21) Appl. No.: 11/077,562

(22) Filed: Mar. 10, 2005

(30) Foreign Application Priority Data
Mar. 11, 2004 (JP) 2004-068615
Mar. 26, 2004 (JP) 2004-092360

(51) Int. Cl. B41J 13/00; G06K 15/16; B65H 7/02

(52) U.S. Cl. 347/104; 271/258.01

(57) ABSTRACT

The invention provides an image forming apparatus that detects abnormality of a recording medium before the recording medium reaches an image recording section and prevents the recording medium having the abnormality from being fed to the image recording section. A recording medium fed from a sheet feeding section is conveyed to the image recording section by a conveying section, an image is formed on the recording medium, and then the recording medium is carried out. When a recording medium abnormality detecting section detects abnormality of the recording medium, which affects the image recording section, between the sheet feeding section and the image recording section, an abnormal discharge section discharges the recording medium via an abnormal time conveying path different from a normal conveying path. Alternatively, an abnormal stop section stops the conveyance of the recording medium before the image recording section.

### BACKGROUND OF THE INVENTION

1. Field of the Invention

The present invention relates to an image forming apparatus that conveys a recording medium, which is fed from a sheet feeding section, to an image recording section with a conveying section to form an image on the recording medium and, then, carries the recording medium out.

2. Description of the Prior Art

As a conventional image forming apparatus, for example, there is provided an ink jet recording apparatus that performs high-speed printing. In this image forming apparatus, a sheet fed from a sheet feeding tray is attracted by a pneumatic sheet attracting device on a conveyor belt, conveyed to a printer head including plural head sections that have ink discharge surfaces, which are fixedly arranged to extend over an entire sheet width, and passed to a sheet discharge tray after ink droplets are discharged on the sheet by the printer head to perform color printing. (For example, see, JP2002-103598A).

For example, in the case of an electrophotographic method, a recording medium passes between rollers, which are in pressed contact with each other, whereby an image transferred from a photosensitive member or an intermediate transfer member onto the recording medium. Consequently, even if the recording medium has a little bend or roll-up, since the recording medium is pressed by the rollers, a problem of sheet jam is less likely to occur.

However, in the case of the ink jet method described in the conventional example, it is possible to perform printing at high speed by conveying a recording sheet to the print head section, which is fixedly arranged, at high speed with the conveyor belt. However, in an image forming section, the recording medium is simply attracted by the sucking air or static electricity from the rear surface of the recording medium. Thus, if the recording medium has bend or roll-up, an attraction force between the recording sheet and the conveyor belt falls. Usually, a space between the print head and a print surface of the recording sheet is set to about 1 mm. As a result, when sheet abnormality occurs in the recording sheet, a leading edge of the recording sheet lifts from a conveyance surface because of curl, in particular, roll-up or bend due to waviness of the recording sheet, the recording sheet and a recording head section come into contact with each other, discharge failure due to head clogging, sheet jam, and the like occur. Therefore, maintenance work is necessary. In the worst case, even the recording head has to be replaced.

Thus, the invention has been devised in view of the unsolved problems of the conventional example and it is an object of the invention to provide an image forming apparatus detects abnormality of a recording medium before the recording medium reaches an image recording section and prevents the recording medium having the abnormality from being fed to the image recording section surely.

### SUMMARY OF THE INVENTION

An image forming apparatus according to an aspect of the invention is an image forming apparatus that conveys a recording medium, which is fed from a sheet feeding section, to an image recording section with a conveying section to form an image on the recording medium and, then, carries the recording medium out, the image forming apparatus including: a recording medium abnormality detecting section that detects abnormality of the recording medium, which affects the image recording section, between the sheet feeding section and the image recording section; and an abnormal discharge section that discharges the recording medium through an abnormal time conveying path different from a normal conveying path when the recording medium abnormality detecting section detects abnormality of the recording medium.

In this aspect of the invention, when the recording medium abnormality detecting section detects abnormality such as roll-up or bend, which affects the image recording section, in the recording medium between the sheet feeding section and the image recording section, the abnormal discharge section discharges the recording medium having the abnormality through the abnormal time conveying path different from the normal conveying path. Thus, the recording medium having the abnormality is never conveyed to the image recording section and it is possible to prevent stain on the image recording section and jam in the image recording section surely. In addition, since the recording medium never stops before the image recording section, work for removing the recording medium does not have to be performed and it is possible to reduce labor and time at the abnormal time significantly.

Here, as the recording medium abnormality detecting section, it is possible to apply an optical sensor such as a laser beam sensor that detects lift of a recording medium from the conveyance surface or a contact type sensor that detects lift of a recording medium from the conveyance surface.

As the abnormal time conveying path, it is possible to apply a recording medium housing section exposed to the outside that houses the recording medium fed from a path selecting section or a recording medium housing section formed inside the image forming apparatus that houses the recording medium fed from the path selecting section. In the case of the recording medium housing section exposed to the outside, it is possible to grasp an abnormal state of the recording medium immediately. In the case the recording medium housing section is formed inside the image forming apparatus, since it is unnecessary to use an upper part or the like of the image forming apparatus as a recording medium housing section, it is possible to use this space effectively.

Moreover, a warning device issuing a warning when the recording medium abnormality detecting section detects abnormality of the recording medium is provided in the abnormal discharge section. Then, since a warning is issued by a liquid crystal display device, a buzzer or the like, when the recording medium abnormality detecting section detects abnormality of the recording medium, a user can grasp the abnormality of the recording medium immediately.

An image forming apparatus according to another aspect of the invention is an image forming apparatus that conveys a recording medium, which is fed from a sheet feeding section, to an image recording section with a conveying section to form an image on the recording medium and, then, carries the recording medium out, the image forming apparatus including: a recording medium abnormality detecting section that detects abnormality of the recording medium, which affects the image recording section, between the sheet feeding section and the image recording section; and an abnormal discharge section having a path selecting section that transfers the recording medium to a normal conveying path when the recording medium abnormality detecting section does not detect abnormality of the recording medium and transfers the recording medium to an abnormal time conveying path when the recording medium abnormality detecting section detects abnormality of the recording medium.

In this aspect of the invention, a recording medium is transferred to the image recording section through the normal conveying path when the recording medium abnormality detecting section does not detect abnormality of the recording medium and is transferred to the abnormal time conveying path when the recording medium abnormality detection section detects abnormality of the recording medium. Consequently, it is possible to prohibit conveyance of the recording medium having the abnormality to the image recording section surely, and it is also possible to prevent an abnormal part of the recording medium from affecting the image recording section surely.

Here, as one constitution of the path selecting section, it is possible to constitute the path selecting section with a spring-up mechanism for springing up a leading edge of the recording medium upward from the normal conveying path when the recording medium abnormality detecting section detects abnormality of the recording medium and a scoop-up mechanism for scooping up a leading edge of the recording medium which is sprung up by the spring-up mechanism to guide this recording medium to the abnormal time conveying path. In this case, when abnormality of a recording medium is detected, the spring-up mechanism springs up a leading edge of the recording medium and the scoop-up mechanism scoops up the sprung-up recording medium and guides the recording medium to the abnormal time conveying path. Thus, it is possible to transfer the recording medium from the normal conveying path to the abnormal time conveying path surely.

As another constitution of the path selecting section, it is possible to constitute the path selecting section by a drive roller fixedly arranged on a side to which the recording medium is fed, a movable roller that is, on a side from which the recording medium is discharged, movable between a normal position connected to the normal conveying path and an abnormal time position connected to the abnormal time conveying path, a conveyor belt which is stretched and suspended between both the rollers, and a roller moving mechanism that moves the movable roller between the normal position and the abnormal time position. In this case, the roller moving mechanism moves the movable roller to the normal position, whereby the recording medium is transferred to the normal conveying path connected to the image recording section. Also, the roller moving mechanism is able to move the movable roller to the abnormal time position, whereby it is possible to transfer the recording medium to the abnormal time conveying path and discharge the recording medium having the abnormality surely without conveying to the image recording section.

An image forming apparatus according to still another aspect of the invention is an image forming apparatus that conveys a recording medium, which is fed from a sheet feeding section, to an image recording section with a conveying section to form an image on the recording medium and, then, carries the recording medium out, the image forming apparatus including: a recording medium abnormality detecting section that detects abnormality of the recording medium, which affects the image recording section, between the sheet feeding section and the image recording section; and an abnormal stopping section that stops the recording medium before reaching the image recording section when the recording medium abnormality detecting section detects abnormality of the recording medium.

In this aspect of the invention, when the recording medium abnormality detecting section detects abnormality of a recording medium, such as roll-up, bend or the like, which affects the image recording section, between the sheet feeding section and the image recording section, the abnormal stopping section stops conveyance of the recording medium having the abnormality to the image recording section. Thus, it is possible to prevent the recording medium having the abnormality from being conveyed to the image recording section and prevent stain on the image recording section and jam in the image recording section surely.

An image forming apparatus according to still another aspect of the invention is an image forming apparatus that conveys a recording medium, which is fed from a sheet feeding section, to an image recording section with a conveying section to form an image on the recording medium and, then, carries the recording medium out, the image forming apparatus including: a recording medium abnormality detecting section that detects lift of the recording medium from a conveyance surface and detects abnormality of the recording medium, which affects the image recording section, between the sheet feeding section and the image recording section; and an abnormal stopping section having a conveyance stopping section that stops the conveying section so as to stop the recording medium before reaching the image recording section when the recording medium abnormality detecting section detects abnormality of the recording medium.

In this aspect of the invention, conveyance of a recording medium by the conveying section is stopped by the conveyance stopping section when abnormality of the recording medium is detected. Thus, it is possible to prohibit the conveyance of the recording medium to the image recording section surely and prevent the abnormality of the recording medium from affecting the image recording section surely.

### BRIEF DESCRIPTION OF THE DRAWINGS

FIG. 1 is a diagram showing an image forming apparatus according to a first embodiment of the invention;

FIGS. 2A and 2B are diagrams showing a recording medium abnormality detecting section in the first embodiment;

FIG. 3 is a block diagram showing a controller in the first embodiment;

FIG. 4 is a flowchart showing an example of a procedure of sheet feed control processing that is executed by a microcomputer of the controller;

FIG. 5 is a flowchart showing an example of a procedure of abnormality detection control processing that is executed by a microcomputer of the controller;

FIG. 6 is a flowchart showing an example of a procedure of recording control processing that is executed by a microcomputer of the controller;

FIG. 7 is a diagram showing an operation at the time when abnormality occurs in a recording sheet;

FIG. 8 is a partially enlarged plan view showing another example of arrangement of solenoids in an abnormal discharge section;

FIG. 9 is a schematic diagram of a main part showing a modified example of the abnormal discharge section;

FIG. 10 is a diagram showing an image forming apparatus according to a second embodiment of the invention;

FIG. 11 is a block diagram showing a controller in the second embodiment;

FIG. 12 is a flowchart showing an example of a procedure of abnormality detection control processing that is executed by a microcomputer of the controller;

FIG. 13 is a diagram showing an operation at the time when abnormality occurs in a recording sheet;

FIGS. 14A and 14B are diagrams showing a modified example of a recording medium abnormality detecting section;

FIGS. 15A and 15B are diagrams showing another modified example of the recording medium abnormality detecting section; and

FIGS. 16A and 16B are diagrams showing still another modified example of the recording medium abnormality detecting section.

### DESCRIPTION OF THE PREFERRED EMBODIMENT

Embodiments of the invention will be hereinafter explained with reference to the accompanying drawings.

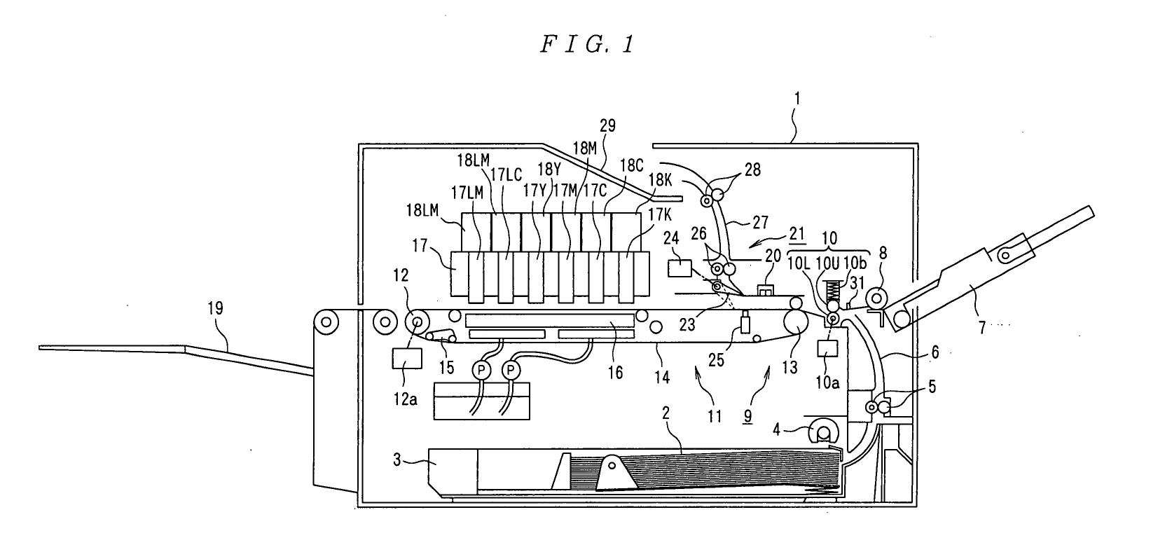

FIG. 1 is a schematic diagram showing a first embodiment of an image forming apparatus according to the invention. In the figure, reference numeral 1 denotes a box type case body. A sheet feeding cassette 3, which serves as a sheet feeding section housing a large number of recording sheets 2 serving as the recording media, is detachably mounted on a bottom of the inside of the case body 1. A sheet feeding roller 4, which feeds the recording sheets 2 one by one, is disposed on a sheet feeding side of the sheet feeding cassette 3. The recording sheet 2 fed by the sheet feeding roller 4 extends while curving upward and is guided by a conveying path 6 having a conveying roller 5 en route to convey to a center side of the case body 1 in a vertical direction.

A sheet feeding port for the recording sheet 2, which is fed from a sheet feeding roller 8 provided in a sheet feeding cassette for hand supply 7 serving as a sheet feeding section, is disposed at an upper end of the conveying path 6. The recording sheet 2 fed from the conveying path 6 or the sheet feeding cassette 7 is supplied to a conveying mechanism 9 serving as a conveying section that conveys this recording sheet 2 in a horizontal direction.

The conveying mechanism 9 has a gate roller 10 that is disposed near a merging point of the recording sheets 2 fed from the conveying path 6 and the sheet feeding cassette 7. The gate roller 10 has an upper roller 10U and a lower roller 10L that rotatory contact with each other. The lower roller 10L is driven to rotate by coupling to an electric motor 10a. The upper roller 10U is pressed by a coil spring 10b so as to rotatory contact with the lower roller 10L at a predetermined pressure. The gate roller 10 is in a stopped or standby state until a leading edge of the recording sheet 2 fed from the conveying path 6 or the sheet feeding cassette 7 comes into contact with the gate roller 10. After the leading edge of the recording sheet 2 comes into contact with the gate roller 10, the lower roller 10L is driven to rotate by the electric motor 10a, whereby the gate roller 10 aligns the recording sheet 2 by adjusting the leading edge of the recording sheet 2 to a direction perpendicular to a conveying direction and passes the recording sheet 2 to a horizontal conveying section 11 forming a normal conveying path in a later stage.

The horizontal conveying section 11 includes a drive roller 12 and a driven roller 13 that are disposed in parallel to each other keeping a predetermined interval, a conveyor belt 14 having a structure in which two belts, which have a wide belt shape and have a large number of through holes formed therein, are stretched and suspended between the drive roller 12 and the driven roller 13 where, in a width direction, a predetermined interval is put in a center, and a tension roller 15 that adjusts a tension of the conveyor belt 14. Here, the drive roller 12 is disposed on a discharge side of the recording sheet 2 and rotatory driven by an electric motor 12a. The driven roller 13 is disposed on a sheet feeding side of the recording sheet 2, that is, the gate roller 10 side.

In the horizontal conveying section 11, an air suction mechanism 16 sucking the air is disposed between the middle of the drive roller 12 and the driven roller 13 and the drive roller 12 in an inner position of the conveyor belt 14 between the drive roller 12 and the driven roller 13 such that an air suction surface thereof is in contact with an inner surface of the conveyor belt 14. The air suction mechanisms 16 sucks the air through the through holes of the upper side conveyor belt 14. Consequently, the horizontal conveying section 11 conveys the recording sheet 2 placed on the conveyor belt 14 while attracting and holding the recording sheet 2 on an upper surface of the conveyor belt 14.

A recording head section 17 serving as an image recording section is fixedly arranged in a position opposed to the air suction mechanism 16 of the horizontal conveying section 11 via the conveyor belt 14. The recording head section 17 is opposed to the recording sheet 2 adhered and held to be conveyed by the conveyer belt 14 while keeping a slight space (e.g., about 1 mm). In this recording head section 17, six line-type recording heads 17K, 17C, 17M, 17Y, 17LC, and 17LM are disposed in the conveying direction of the recording sheet 2 while keeping a predetermined interval. The recording heads 17K to 17LM discharge ink droplets of black, cyan, magenta, yellow, light cyan, and light magenta to the recording sheet 2, respectively. A recording area, in which a large number of nozzles for discharging ink droplets in a width direction orthogonal to the conveying direction of the recording sheet 2 are arranged at very small intervals, is formed in each of the recording head 17K to 17LM. The ink droplets discharged by the recording heads 17C to 17LM excluding the recording head 17K for black are superimposed one on top of another on the recording sheet 2, whereby color printing can be performed. Inks of black, cyan, magenta, yellow, light cyan, and light magenta are supplied to the recording head 17K to 17LM from ink tanks 18K to 18LM. The inks in the ink tanks 18K to 18LM are replaced by, for example, opening and closing an upper surface of the case body 1.

When the recording sheet 2 conveyed by the conveyor belt 14 of the horizontal conveying section 11 reaches the drive roller 12 side, the recording sheet 2 is passed to a sheet discharge stacker 19, which is arranged on the outside of the case body 1 in the conveying direction of the recording sheet 2 further than the drive roller 12.

On the other hand, a recording medium abnormality detecting section 20 is disposed in a position slightly closer to the drive roller 12 side than the driven roller 13 further in a front position than the recording head section 17. The recording medium abnormality detecting section 20 detects abnormality of lift of the recording sheet 2, which is conveyed by the conveyor belt 14, from the conveyance surface due to roll-up, bend, or the like that comes into contact with and affects the recording head section 17. An abnormal discharge section 21, which is opposed to the conveyor belt 14 from the above, is disposed further on the drive roller 12 side than the recording medium abnormality detecting section 20 and further on the driven roller 13 side than the recording head section 17.

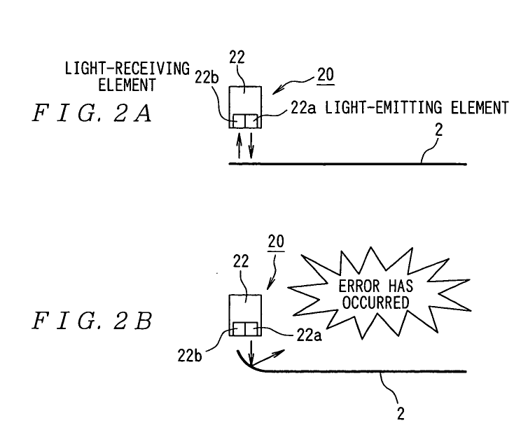

Here, as shown in FIGS. 2A and 2B, the recording medium abnormality detecting section 20 includes an optical sensor 22. In the optical sensor 22, a light-emitting element 22a and a light-receiving element 22b are arranged in close contact with each other such that light emitted from the light-emitting element 22a toward the conveyor belt 14 is reflected on the conveyor belt 14 or the recording sheet 2 conveyed by the conveyor belt 14 and then, this reflected light is made incident on the light-receiving element 22b.

The abnormal discharge section 21 includes a flipper 23 serving as a scoop-up mechanism, a rotational movement drive mechanism 24, a solenoid 25 serving as a spring-up mechanism, a pair of discharge rollers 26, an abnormal time conveying path 27, a pair of conveying rollers 28, and an abnormal recording sheet stacker 29. The flipper 23 is disposed to be capable of moving rotationally between a standby position further on a rear side than the optical sensor 22 where the flipper 23 is apart upward from the recording sheet 2 conveyed by the conveyor belt 13 and a scoop-up position to which the flipper 23 moves rotationally in a counterclockwise direction from the standby position to be capable of scooping up the recording sheet 2. The rotational movement drive mechanism 24 that rotatory drives to move the flipper 23 between the standby position and the scoop-up position. The solenoid 25 springs up the recording sheet 2 placed in a gap made by the conveyor belt 13 in the center of a front side of the flipper 23. The discharge rollers 26 discharge the recording sheet 2 scooped up by the flipper 23. The abnormal time conveying path 27 that guides the recording sheet 2 discharged by the discharge rollers 26 upward. The conveying rollers 28 are disposed along the abnormal time conveying path 27. The abnormal recording sheet stacker 29 is provided on the upper surface of the case body 1 opposed to an upper end of the abnormal time conveying path 27. The flipper 23 and the solenoid 25 constitute a path selecting section.

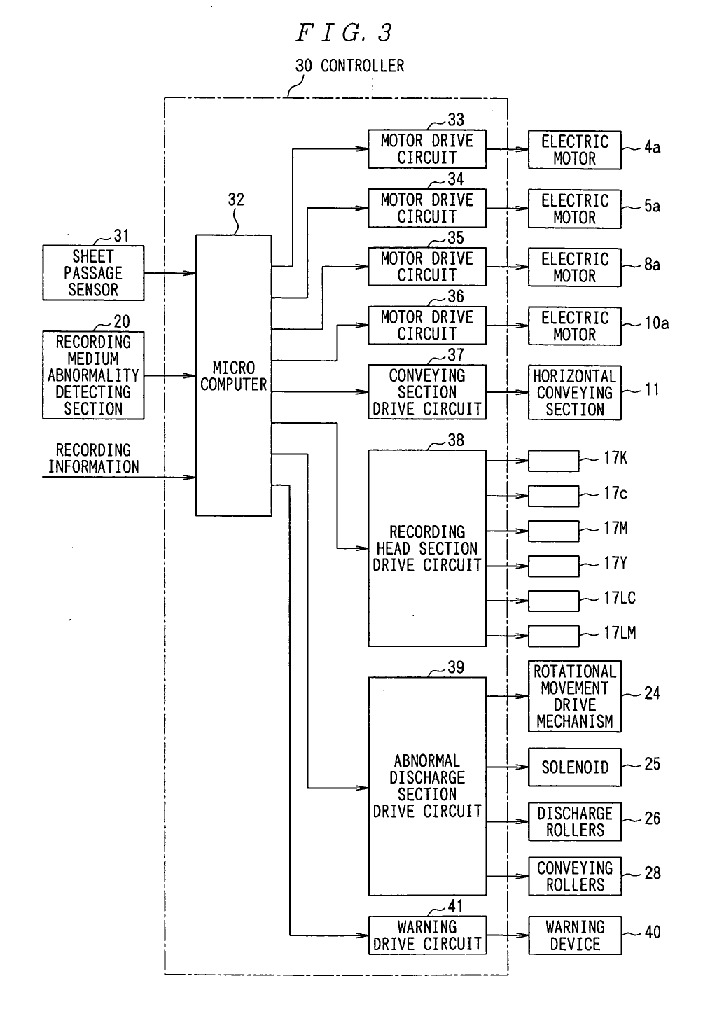

As shown in FIG. 3, a controller 30 controls drive of the sheet feeding roller 4, the conveying roller 5, the gate roller 10, the horizontal conveying section 11, the recording heads 17K to 17LM and the abnormal discharge section 21.

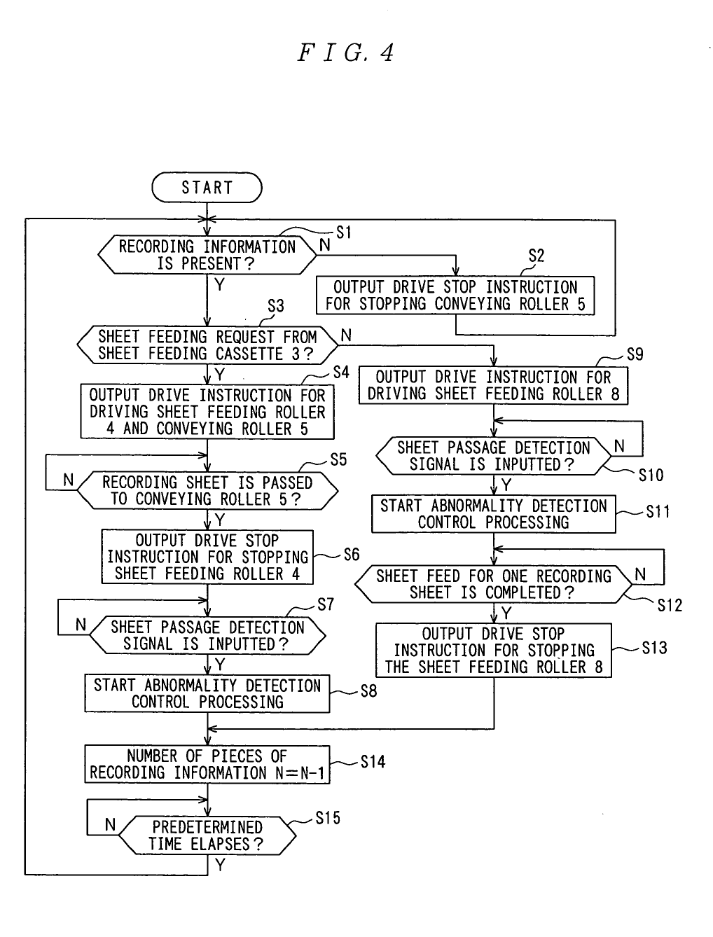

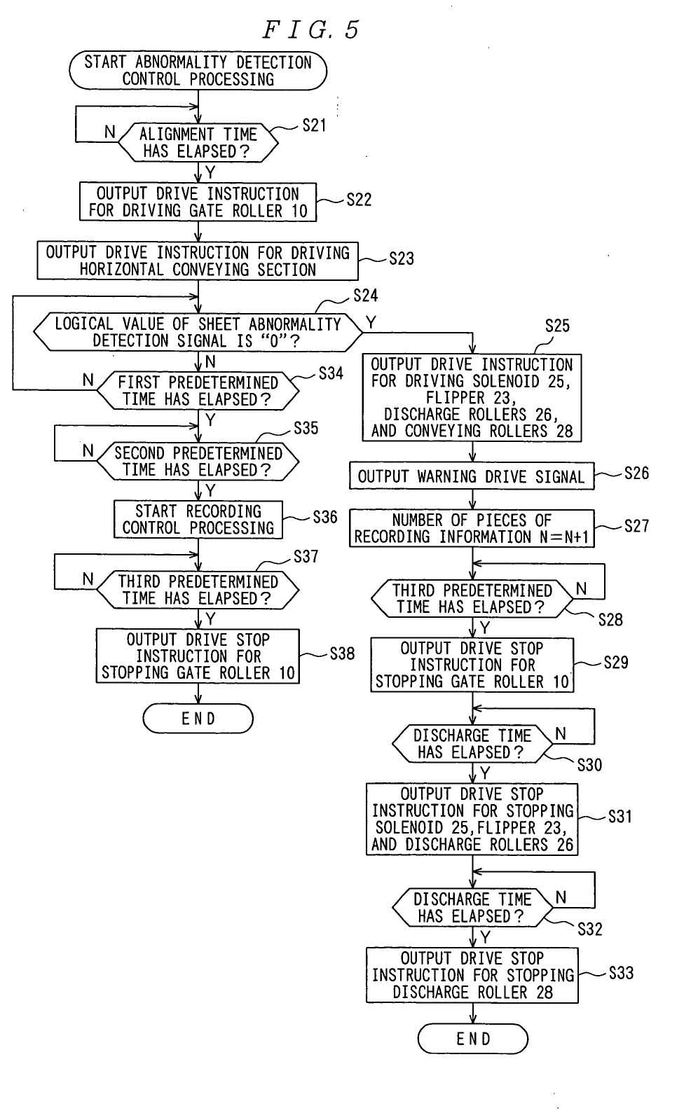

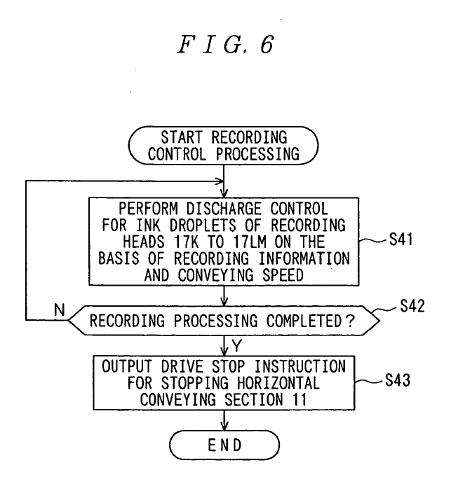

The controller 30 has a microcomputer 32, a motor drive circuit 33, a motor drive circuit 34, a motor drive circuit 35, a motor drive circuit 36, a conveying section drive circuit 37, a head drive circuit 38, an abnormal discharge section drive circuit 39, and a warning drive circuit 41. The microcomputer 32 is inputted with a sheet leading edge detection signal detected by a sheet passage sensor 31, which is disposed on the front side of the gate roller 10 and detects the leading edge of the recording sheet 2, for example, optically, and also inputted with recording information from a print information forming apparatus such as a host computer on the outside and executes sheet feed control processing shown in FIG. 4, abnormality detection control processing shown in FIG. 5, and recording control processing shown in FIG. 6 on the basis of the sheet leading edge detection signal and the recording information. The motor drive circuit 33 controls an electric motor 4a for the sheet feeding roller 4 to which a drive instruction outputted from the microcomputer 32 is inputted. The motor drive circuit 34 controls an electric motor 5a for the conveying roller 5. The motor drive circuit 35 controls an electric motor 8a for the sheet feeding roller 8 on the sheet feeding cassette for hand supply 7 side. The motor drive circuit 36 controls the electric motor 10a for the gate roller 10. The conveying section drive circuit 37 controls the electric motor 12a for the drive roller 12 and the air suction mechanism 16 in the horizontal conveying section 11. The head drive circuit 38 controls the recording heads 17K to 17LM. The abnormal discharge section drive circuit 39 controls the rotational movement drive mechanism 24 of the flipper 23, the solenoid 25, the discharge rollers 26, and the conveying rollers 28 in the abnormal discharge section 21. The warning drive circuit 41 drives a warning device 40 including a liquid crystal display device, a buzzer, or the like that issues a warning.

In the sheet feed control executed by the microcomputer 32, as shown in FIG. 4, first, in step S1, the microcomputer 32 judges whether recording information to be recorded is present. When no recording information is present, the microcomputer 32 shifts to step S2, outputs a drive stop instruction for stopping the conveying roller 5 to the motor drive circuit 34, and then returns to step S1. When recording information is present, the microcomputer 32 shifts to step S3.

In step S3, the microcomputer 32 judges whether recording information has a sheet feed request from the sheet feeding cassette 3. When the recording information has a sheet feed request from the sheet feeding cassette 3, the microcomputer 32 shifts to step S4. In step S4, the microcomputer 32 outputs a motor drive instruction for starting rotation of the sheet feeding roller 4 to the motor drive circuit 33 and outputs a motor drive instruction for starting rotation of the conveying roller 5 to the motor drive circuit 34. Subsequently, the microcomputer 32 shifts to step S5.

In step S5, the microcomputer 32 judges whether sheet feed time sufficient for the leading edge of the recording sheet 2 to be passed to the conveying roller 5 has elapsed. When the sheet feed time has not elapsed, the microcomputer 32 stands for elapse of the sheet feed time. When the sheet feed time has elapsed, the microcomputer 32 shifts to step S6 and outputs a drive stop instruction for stopping the sheet feeding roller 4 to the motor drive circuit 33. Subsequently, the microcomputer 32 shifts to step S7 and judges whether a sheet passage detection signal is inputted from the sheet passage sensor 31. When a sheet passage detection signal is not inputted, the microcomputer 32 stands by for input of a sheet passage signal. When a sheet passage signal is inputted, the microcomputer 32 shifts to step S8, starts the abnormality detection control processing in FIG. 5, and then shifts to step S14.

When a result of the judgment in step S3 indicates a sheet feed request from the sheet feeding cassette for hand supply 7, the microcomputer 32 shifts to step S9 and outputs a motor drive instruction for starting rotation of the sheet feeding roller 8 to the motor drive circuit 35. Subsequently, the microcomputer 32 shifts to step S10 and judges whether a sheet passage detection signal is inputted from the sheet passage sensor 31. When a sheet passage detection signal is not inputted, the microcomputer 32 stands by for input of a sheet passage detection signal. When a sheet passage detection signal is inputted, the microcomputer 32 shifts to step S11. In step S11, the microcomputer 32 starts the abnormality control processing in FIG. 5 and, then, shifts to step S12. In step S12, the microcomputer 32 judges whether sheet feed for one recording sheet 2 is completed. When the sheet feed is not completed, the microcomputer 32 stands by for completion of the sheet feed. When the sheet feed is completed, the microcomputer 32 shifts to step S13, outputs a drive stop instruction for stopping the sheet feeding roller 8 to the motor drive circuit 35, and then shifts to step S14.

In step S14, the microcomputer 32 decrements the number of pieces of recording information N and, then, shifts to step S15. In step S15, the microcomputer 32 judges whether a predetermined time necessary for starting the next sheet feed has elapsed. When the predetermined time has not elapsed, the microcomputer 32 stands by for elapse of the predetermined time. When the predetermined time has elapsed, the microcomputer 32 returns to step S1.

In the abnormality detection control processing in FIG. 5, first, in step S21, the microcomputer 32 judges whether an alignment time sufficient for the leading edge of the recording sheet 2 to reach the gate controller 10 has elapsed. When the alignment time has not elapsed, the microcomputer 32 stands by for elapse of the alignment time. When the alignment time has elapsed, the microcomputer 32 shifts to step S22 and outputs a drive instruction to the motor drive circuit 36 for the gate roller 10. Subsequently, the microcomputer 32 shifts to step S23, outputs a drive instruction to the conveying section drive circuit 37 for the horizontal conveying section 11 to rotatory drive control the electric motor 12a for the drive roller 12 and bring the air suction mechanism 16 into an actuated state, and then shifts to step S24.

In step S24, the microcomputer 32 judges a logical value of an abnormality detection signal inputted from the optical sensor 22 of the recording medium abnormality detecting section 20. When the logical value of the abnormality detection signal is “0”, the microcomputer 32 judges that abnormality due to roll-up, bend, or the like occurs at the leading edge of the recording sheet 2 and shifts to step S25. In step S25, the microcomputer 32 outputs a drive instruction to the abnormal discharge section drive circuit 39 to bring the solenoid 25, the flipper 23, the discharge rollers 26, and the conveying rollers 28 into a drive state. Subsequently, the microcomputer 32 shifts to step S26 and outputs a warning drive signal to the warning drive circuit 41. Then, the microcomputer 32 shifts to step S27, increments the number of pieces of recording information N, and then shifts to step S28.

In step S28, the microcomputer 32 judges whether a third predetermined time sufficient for a trailing edge of the recording sheet 2 to move out from the gate roller 10 has elapsed. When the third predetermined time has not elapsed, the microcomputer 32 stands by for elapse of the third predetermined time. When the third predetermined time has elapsed, the microcomputer 32 shifts to step S29, outputs a drive stop instruction for stopping the gate roller 10 to the motor drive circuit 36, and then shifts to step S30.

In step S30, the microcomputer 32 judges whether a discharge time sufficient for housing the recording sheet 2 having abnormality in the abnormal recording sheet stacker 29 has elapsed. When the discharge time has not elapsed, the microcomputer 32 stands by for elapse of the discharge time. When the discharge time has elapsed, the microcomputer 32 shifts to step S31. In step S31, the microcomputer 32 outputs a drive stop instruction for stopping the solenoid 25, the flipper 23, the discharge rollers 26, and the conveying rollers 28 to the abnormal discharge section drive circuit 39 and, then, shifts to step S32.

In step S32, the microcomputer 32 judges whether a sheet discharge time, in which the time sufficient to discharge recording sheet 2 to the abnormal recording sheet stacker 29, has elapsed. When the sheet discharge time has not elapsed, the microcomputer 32 stands by for elapse of the sheet discharge time. When the sheet discharge time has elapsed, the microcomputer 32 shifts to step S33, outputs a drive stop instruction for stopping the conveying rollers 28 to the abnormal discharge section drive circuit 39, and then ends the abnormality detection control processing.

On the other hand, when the logical value of the abnormality detection signal is “1” as a result of the judgment in step S24, the microcomputer 32 judges that abnormality has not occurred in the recording sheet 2 and shifts to step S34. In step S34, the microcomputer 32 judges whether a first predetermined time sufficient for the leading edge of the recording sheet 2 to pass a recording medium abnormality detecting section 20 from the gate controller 10 has elapsed. When the first predetermined time has not elapsed, the microcomputer 32 returns to step S24. When the first predetermined time has elapsed, the microcomputer 32 shifts to step S35.

In step S35, the microcomputer 32 judges whether a second predetermined time until a leading edge of a recording area of the recording sheet 2 reaches the recording head 17K, which discharges a black ink, in the recording head section 17 from the gate roller 10 has elapsed. When the second predetermined time has not elapsed, the microcomputer 32 stands by for elapse of the second predetermined time. When the second predetermined time has elapsed, the microcomputer 32 judges that the leading edge of the recording area of the recording sheet has reached a recording area of the recording head 17K and shifts to step S36. In step S36, the microcomputer 32 starts the recording control processing in FIG. 6 and, then, shifts to step S37.

In step S37, the microcomputer 32 judges whether the third predetermined time sufficient for the trailing edge of the recording sheet 2 to move out from the gate roller 10 has elapsed. When the third predetermined time has not elapsed, the microcomputer 32 stands by for elapse of the third predetermined time. When the third predetermined time has elapsed, the microcomputer 32 shifts to step S38, outputs a drive stop instruction for stopping the gate roller 10 to the motor drive circuit 36, and then ends the abnormality detection control processing.

In the recording control processing in FIG. 6, first, in step S41, the microcomputer 32 performs discharge control for ink droplets, which are discharged to the recording sheet 2 from the respective recording heads 17K to 17LM, on the basis of print information and conveying speed of the recording sheet 2. Subsequently, the microcomputer 32 shifts to step S42 and judges whether recording processing for the recording sheet 2 has ended. When the recording processing has not ended, the microcomputer 32 returns to step S41. When the recording processing has ended, the microcomputer 32 shifts to step S43, outputs a drive stop instruction for stopping the horizontal conveying section 11 to the conveying section drive circuit 37, and then ends the recording control processing.

Next, an operation in the first embodiment will be explained.

First, when a power supply of the image forming apparatus is turned on, the controller 30 comes into an actuated state to start execution of printing control processing in FIG. 4.

In this case, when print information is not inputted to the controller 30 from the print information forming apparatus on the outside, the microcomputer 32 stands by for input of print information (step S1), and sheet feeding from the sheet feeding cassette 3 and the sheet feeding cassette for hand supply 7 is in a stopped state. The horizontal conveying section 11 and the recording head section 17 are also in an actuation stopped state.

When print information designating, for example, the sheet feeding cassette 3 is inputted to the controller 30 from the print information forming apparatus on the outside from this actuation stopped state, in the sheet feeding control processing shown in FIG. 4, the microcomputer 32 shifts to step S4 through steps S1 and S3. In step S4, the microcomputer 32 outputs a drive instruction for driving the electric motors 4a and 5a, which drive the sheet feeding roller 4 and the conveying roller 5, to the motor drive circuits 33 and 34 to start drive of the sheet feeding roller 4 and the conveying roller 5. Then, one recording sheet 2 is conveyed from the sheet feeding cassette 3 to the gate roller 10 through the conveying path 6.

When the recording sheet 2 is passed to the conveying roller 5, the microcomputer 32 stops drive of the sheet feeding roller 4 (step S6). Subsequently, when the leading edge of the recording sheet 2 conveyed by the conveying roller 5 reaches the sheet passage sensor 31, a sheet passage detection signal is inputted to the microcomputer 32 from the sheet passage sensor 31, and the abnormality detection control processing shown in FIG. 5 is started.

Thereafter, the microcomputer 32 decrements the number of pieces of recording information and, then, stands by for elapse of a predetermined time until the next sheet feeding is started. When the predetermined time has elapsed, the microcomputer 32 returns to step S1 and, when recording information is present, repeats the sheet feeding operation.

On the other hand, when the leading edge of the recording sheet 2 reaches the sheet passage sensor 31 and execution of the abnormality detection control processing in FIG. 5 is started, the microcomputer 32 drives the gate roller 10 to rotate after an alignment time sufficient for the recording sheet 2 to come into an aligned state, in which the leading edge of the recording sheet 2 comes into contact with a pair of rollers 10U and 10L of the gate roller 10 entirely, elapses (step S22).

Consequently, the recording sheet 2 aligned in a conveying direction of the horizontal conveying section 11 is conveyed and passed to the conveyor belt 14 of the horizontal conveying section 11 by the gate controller 10. The leading edge of the recording sheet 2 reaches the optical sensor 22 of the recording medium abnormality detecting section 20. In the optical sensor 22, light emitted from the light-emitting element 22a when the recording sheet 2 is not present is reflected on the surface of the conveyor belt 13. The reflected light is made incident on the light-receiving element 22b. Consequently, a signal with a logical value “1” indicating a normal state is inputted to the microcomputer 32 from the light-receiving element 22b. When the leading edge of the recording sheet 2 reaches the recording medium abnormality detecting section 20 and lift due to roll-up or bend does not occur at the leading edge, as shown in FIG. 2A, light emitted from the light-emitting element 22a is reflected on the recording sheet 2 and the reflected light reaches the light-receiving element 22b. Consequently, a signal with a logical value “1” indicating the recording sheet 2 is normal is outputted to the microcomputer 32 from the light-receiving element 22b.

Therefore, in the processing in FIG. 5, when the recording sheet 2 is normal, a signal for continuing the logical value “1” is outputted from the optical sensor 22 before and after the recording sheet 2 reaches the optical sensor 22 of the recording medium abnormality detecting section 20. Thus, the microcomputer 32 shifts from step S24 to step S34. When the first predetermined time, in which the leading edge of the recording sheet 2 passes through the recording medium abnormality detecting section 20, elapses, the microcomputer 32 shifts to step S35. When the second predetermined time, in which the leading edge of the recording area of the recording sheet 2 reaches the recording area of the first recording head 17K of the recording head section 17, elapses, the microcomputer 32 shifts to step S36. When the third predetermined time, in which the trailing edge of the recording sheet 2 moves out of the gate roller 10, elapses after the recording control processing in FIG. 6 is started, the microcomputer 32 outputs a drive stop instruction for stopping the gate roller 10 to the motor drive circuit 36. The drive of the gate roller 10 is stopped (step S38).

On the other hand, in the recording control processing in FIG. 6, discharge control for ink droplets in the respective recording heads 17K to 17LM is performed on the basis of recording information inputted to the microcomputer 32 and conveying speed of the recording sheet 2. A recording image corresponding to the recording information is recorded on the recording sheet 2 in color and, then, discharged to the sheet discharge stacker 19.

However, lift affecting the recording head section 17 may occur at the leading edge of the recording sheet 2, which is conveyed by the gate roller 10, because of roll-up or bend. In such a case, when the leading edge of the recording sheet 2 reaches a position opposed to the optical sensor 22 of the recording medium abnormality detecting section 20, as shown in FIG. 2B, light emitted from the light-emitting element 22a and reflected at the leading edge of the recording sheet 2 is never made incident on the light-receiving element 22b. Thus, an abnormality signal with a logical value “0” indicating abnormality of the recording sheet 2 is outputted to the microcomputer 32 from the light-receiving element 22b.

Therefore, in the abnormality detection processing in FIG. 5, the microcomputer 32 shifts from step S24 to step S25. The solenoid 25 is started and a top end of the solenoid 25 projects onto the conveyor belt 13 and springs up the leading edge of the recording sheet 2. The flipper 23 is rotatory moved from a standby position to a scoop-up position to scoop up the leading edge of the recording sheet 2.

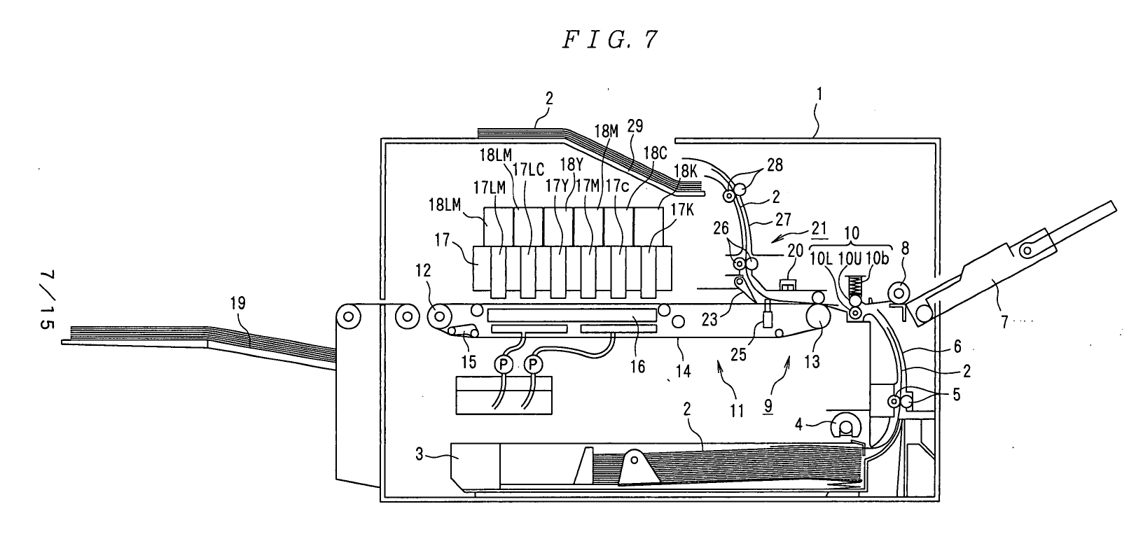

Therefore, as shown in FIG. 7, the recording sheet 2 is guided into the discharge rollers 26 from the flipper 23, passed to the conveying rollers 28 through the abnormal time conveying path 27 by the discharge rollers 26, and discharged to the abnormal recording sheet stacker 29 by the conveying rollers 28. Then, the microcomputer 32 outputs a warning drive signal to the warning drive circuit 41 (step S26). Subsequently, the microcomputer 32 increments the number of pieces of recording information N (step S27) and, then, judges whether the third predetermined time described later, in which the trailing edge of the recording sheet 2 moves out of the gate roller 10, has elapsed (step S28). When the third predetermined time has not elapsed, the microcomputer 32 stands by for elapse of the third predetermined time. When the third predetermined time has elapsed, the microcomputer 32 outputs a drive stop instruction for stopping the gate roller 10 to the motor drive circuit 36 to stop rotation of the gate roller 10 (step S29). Subsequently, when a discharge time sufficient for the trailing edge of the recording sheet 2 having the abnormality to reach the position of the discharge rollers 26 elapses, the microcomputer 32 brings the solenoid 25 into an un-actuated state to set the top end of the solenoid 25 lower than the surface of the conveyor belt 13, and returns the flipper 23 to the standby position (step S31). Thereafter, time sufficient for the recording sheet 2 to be housed in the abnormal recording sheet stacker 29 elapses, the microcomputer 32 outputs a drive stop instruction for stopping the conveying rollers 28 and, then, ends the abnormality detection control processing (step S33).

In this way, the recording sheet 2, in which lift affecting the recording head section 17 is occurred at the leading edge, is detected by the recording medium abnormality detecting section 20. The recording sheet 2 is discharged to the abnormal recording sheet stacker 29 by the abnormal discharge section 21 without being fed to the recording head section 17. Thus, it is possible to surely prevent the recording sheet 2 having the abnormality from being fed to the recording head section 17 and coming into contact with the recording head section 17 to cause not only stain on recording media, but also stain on and damage to an ink discharge surface of the recording head section 17 or discharge failure, sheet jam, and the like due to clogging of the recording head section 17.

Moreover, the recording sheet 2 having the abnormality is automatically discharged to the abnormal recording sheet stacker 29. Thus, labor is not required for discharging the recording sheet 2 having the abnormality to the outside, it is unnecessary to perform troublesome recording sheet discharge processing, a throughput can be improved, and the recording sheet 2 having the abnormality is housed in the abnormal recording sheet stacker 29 exposed to the outside. Thus, a user can grasp an abnormal state of the recording sheet 2 immediately.

Incidentally, in the case of the conventional example, when jam occurs, the user notifies the jam only when the user takes the recording sheet 2 from the image forming apparatus. Since image recording for the remaining recording sheets is resumed after the jam is eliminated, long time is required until the image recording is resumed. However, in the invention, the recording sheet 2 having abnormality is detected before the recording head section 17 and discharged to the outside. Thus, the image forming apparatus itself never stops and it is possible to obtain recording on a desired recording sheet and the number of recorded sheets surely.

When a sheet feed request for feeding a sheet from the sheet feeding cassette for hand supply 7 is present in recording information, the sheet feeding roller 8 of the sheet feeding cassette for hand supply 7 is driven to rotate, and the recording sheet 2 is sent to the sheet passage sensor 31. When a sheet passage detection signal is inputted to the microcomputer 32 from the sheet passage sensor 31, the abnormality detection control processing in FIG. 5 is started. When sheet feeding for one recording sheet 2 is completed, drive of the sheet feeding roller 8 is stopped. The microcomputer 32 is on standby until the next sheet feeding time comes after the number of pieces of recording information is decremented and, then, returns to step S1. When recording information is present, the microcomputer 32 repeats the processing.

Even in the state in which the recording sheet 2 is fed from the sheet feeding cassette for hand supply 7, when the abnormality detection control processing in FIG. 5 is executed, the gate roller 10 is driven to rotate to pass the recording sheet 2 to the conveyor belt 14. When the leading edge of the recording sheet 2 reaches the recording medium abnormality detecting section 20, presence or absence of abnormality of lift of the leading edge of the recording sheet 2 is detected and the same processing as at the time when the recording sheet 2 is fed from the sheet feeding cassette 3 is executed.

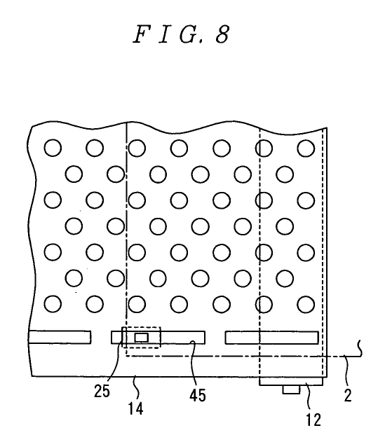

Note that, in the explanation of the first embodiment, the conveyor belt 14 includes two belts disposed in parallel to each other and the solenoid 25 is disposed in the space between the belts. However, the invention is not limited to this. As shown in FIG. 8, it is also possible that solenoid through holes 45 extending in the conveying direction of the conveyor belt 14, which includes one wide belt, are formed at predetermined intervals in positions opposed to both ends in the width direction of the recording sheet 2, in edges at both ends perpendicular to the conveying direction, and the solenoid 25 is arranged on the lower surface side opposed to the solenoid through holes 45. In this case, it is possible to spring up the recording sheet 2 at the both ends in the width direction at the leading edge of the recording sheet 2 with the solenoid 25 and scoop up the recording sheet 2 with the flipper 23 more surely.

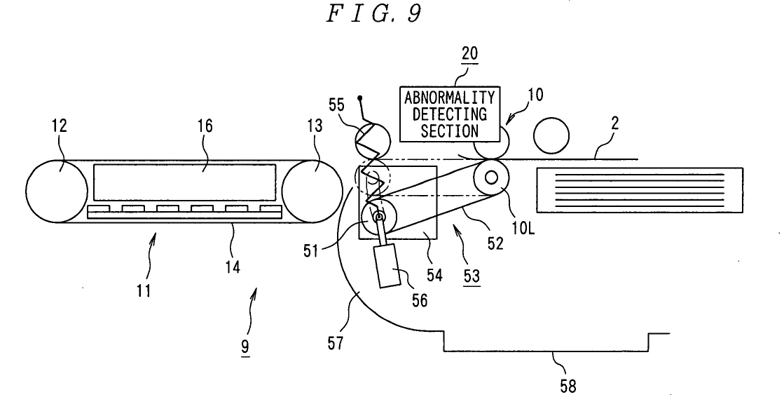

In addition, in the explanation of the embodiment, the recording sheet 2 having the abnormality is discharged to the abnormal recording sheet stacker 29 provided above the case body 1. However, the invention is not limited to this. As shown in FIG. 9, a path selecting mechanism 53 serving as a path selecting section is provided between the horizontal conveying section 11 and the gate roller 10. The path selecting mechanism 53 includes the lower side gate roller 10L serving as a drive roller rotatory driven by a not-shown electric motor, a driven roller 51, and a conveyor belt 52 stretched and suspended between the gate roller 10L and the driven roller 51. The driven roller 51 on the conveying mechanism 10 side of the path selecting mechanism 53 is guided by a guide member 54 so as to be movable between a normal position where the conveyor belt 52 is set in a horizontal state to be continuously connected to a normal conveying path destined for the image recording section 17 and an abnormal discharge position where the conveyor belt 52 is slanted lowering backwards to be continuously connected to the abnormal time conveying path. Usually, the driven roller 51 is maintained in the normal position by a spring 55. When abnormality of the recording sheet 2 is detected by the abnormality detecting section 20, the driven roller 51 is moved to the abnormal discharge position by an elevating mechanism 56 against the spring 55. In this state, the recording sheet 2 is guided by a discharge guide 57, which serves as the abnormal time conveying path, to be discharged downward and housed in an abnormal recording medium stacker 58. Since the abnormal recording medium stacker 58 is formed inside the apparatus in this way, it is unnecessary to provide the abnormal recording sheet stacker 29 above the case body 1 as in the embodiment described above. Thus, it is possible to use the upper surface of the case body 1 effectively as, for example, an opening and closing section for replacement of ink or a mounting stand.

Moreover, in the explanation of the first embodiment, the conveying mechanism 9 includes the horizontal conveying section 11. However, the invention is not limited to this and it is also possible to apply a conveying mechanism having an electrostatic attraction drum. In this case, recording heads 12Y to 12K only have to be arranged radially while keeping predetermined intervals on a conveying drum that attracts and conveys a recording sheet.

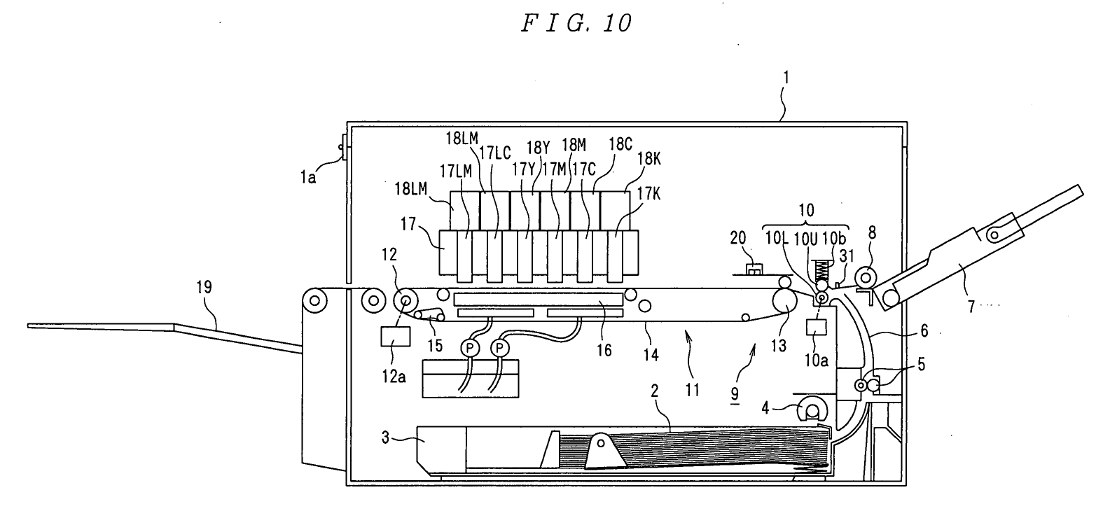

Next, an image forming apparatus according to a second embodiment of the invention will be explained with reference to FIGS. 10 to 13.

In the second embodiment, instead of providing the abnormal time conveying path as in the first embodiment, conveyance of the recording sheet 2 is stopped before reaching the recording head section 17 when abnormality of the recording sheet 2 is detected.

In the second embodiment, as shown in FIG. 10, the image forming apparatus has the same structure as the image forming apparatus according to the first embodiment shown in FIG. 1 except that the abnormal discharging section 21 is not provided. Components corresponding to those in FIG. 1 are denoted by the identical reference numerals and signs and detailed explanations of the components are omitted.

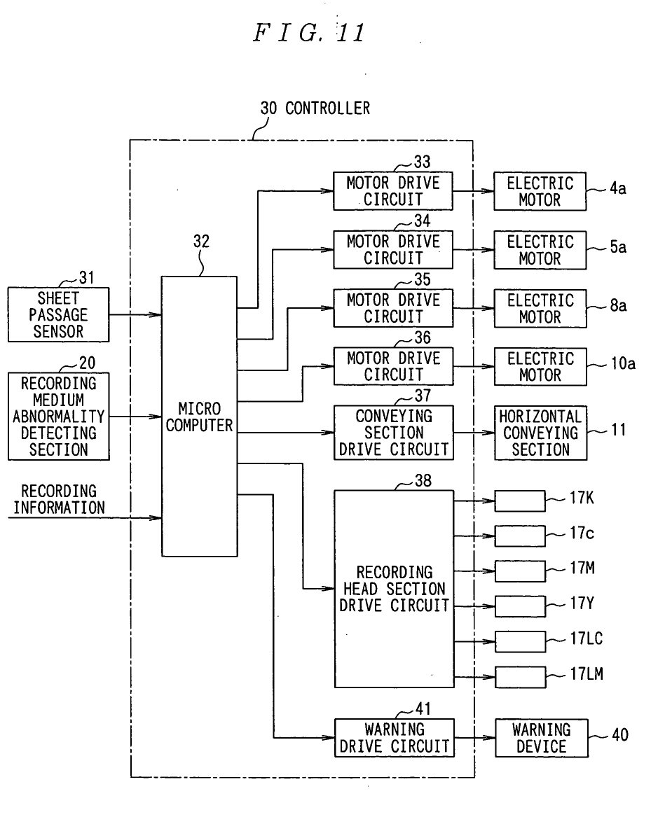

As shown in FIG. 11, the controller 30 has the same structure as that in the first embodiment shown in FIG. 3 except that the abnormal discharging section drive circuit 39 is not provided. Components corresponding to those in FIG. 3 are denoted by the identical reference numerals and signs and detailed explanations of the components are omitted.

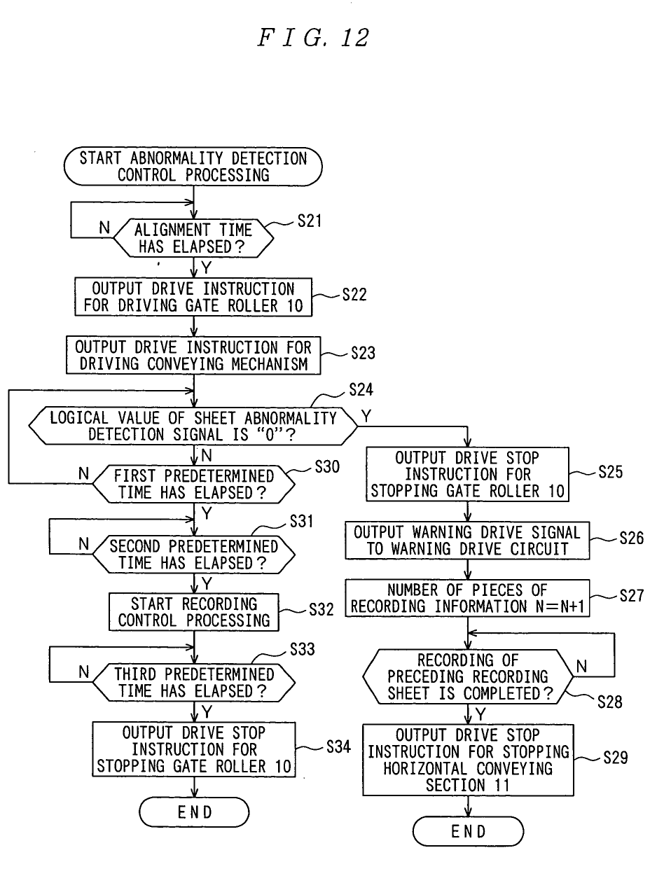

The microcomputer 32 of the controller 30 executes the print control processing in FIG. 4 and the recording control processing in FIG. 6 in the first embodiment. The abnormality detection control processing is changed as shown in FIG. 12.

In the abnormality detection control processing, first, in step S21, the microcomputer 32 judges whether alignment time sufficient for the leading edge of the recording sheet 2 to reach the gate roller 10 has elapsed. When the alignment time has not elapsed, the microcomputer 32 stands by for elapse of the alignment time. When the alignment time has elapsed, the microcomputer 32 shifts to step S22 and outputs a drive instruction to the motor drive circuit 36 of the gate roller 10. Subsequently, the microcomputer 32 shifts to step S23 and outputs a drive instruction for driving the horizontal conveying section 11 to the conveying section drive circuit 37 to rotatory drive the electric motor 12a of the drive roller 12 and brings the air suction mechanism 16 into an actuated state. Then, the microcomputer 32 shifts to step S24.

In step S24, the microcomputer 32 judges a logical value of an abnormality detection signal inputted from the optical sensor 22 of the recording medium abnormality detecting section 20. When the logical value of the abnormality detection signal is “0”, the microcomputer 32 judges that abnormality due to roll-up, bend, or the like occurs at the leading edge of the recording sheet 2 and shifts to step S25. In step S25, the microcomputer 32 outputs a drive stop instruction to the electric motor 10a for the gate roller 10 and, then, shifts to step S26. In step S26, the microcomputer 32 outputs a warning drive signal to the warning drive circuit 41. Subsequently, the microcomputer 32 shifts to step S27, increments the number of pieces of recording information N, and then shifts to step S28.

In step S28, the microcomputer 32 judges whether a conveyance stop time sufficient for completing color printing on the preceding recording sheet 2 by the recording head section 17 has elapsed. When the conveyance stop time has not elapsed, the microcomputer 32 stands by for elapse of the conveyance stop time. When the conveyance stop time has elapsed, the microcomputer 32 shifts to step S29. In step S29, the microcomputer 32 outputs a drive stop instruction for bringing the drive motor 12a for the drive roller 12 and the air suction mechanism 16 of the horizontal conveying section 11 into a drive stop state and, then, ends the abnormality detection control processing.

On the other hand, when the logical value of the abnormality detection signal is “1” as a result of the judgment in step S24, the microcomputer 32 judges that abnormality has not occurred in the recording sheet 2 and shifts to step S30. In step S30, the microcomputer 32 judges whether a first predetermined time sufficient for the leading edge of the recording sheet 2 to pass the recording medium abnormality detecting section 20 from the gate controller 10 has elapsed. When the first predetermined time has not elapsed, the microcomputer 32 returns to step S24. When the first predetermined time has elapsed, the microcomputer 32 shifts to step S31.

In step S31, the microcomputer 32 judges whether a second predetermined time for a leading edge of a recording area of the recording sheet 2 to reach the recording head 17K, which discharges a black ink, in the recording head section 17 from the gate roller 10 has elapsed. When the second predetermined time has not elapsed, the microcomputer 32 stands by for elapse of the second predetermined time. When the second predetermined time has elapsed, the microcomputer 32 judges that the leading edge of the recording area of the recording sheet 2 has reached a recording area of the recording head 17K and shifts to step S32. In step S32, the microcomputer 32 starts the recording control processing in FIG. 6 and, then, shifts to step S33.

In step S33, the microcomputer 32 judges whether a third predetermined time sufficient for the trailing edge of the recording sheet 2 to move out from the gate roller 10 has elapsed. When the third predetermined time has not elapsed, the microcomputer 32 stands by for elapse of the third predetermined time. When the third predetermined time has elapsed, the microcomputer 32 shifts to step S34, outputs a drive stop instruction for stopping the gate roller 10 to the motor drive circuit 36, and then ends the abnormality detection control processing.

In the processing in FIG. 12, the processing in steps S24 to S26 corresponds to an abnormal stopping section.

Next, an operation in the second embodiment will be explained.

First, when a power supply of the image forming apparatus is turned on, the controller 30 comes into an actuated state to start execution of the printing control processing in FIG. 4.

In this case, when print information is not inputted to the controller 30 from the print information forming apparatus on the outside, the microcomputer 32 stands by for input of print information (step S1), and the sheet feeding from the sheet feeding cassette 3 and the sheet feeding cassette for hand supply 7 is in a stopped state. The horizontal conveying section 11 and the recording head section 17 are also in an actuation stopped state.

When print information designating, for example, the sheet feeding cassette 3 is inputted to the controller 30 from the print information forming apparatus on the outside in this actuation stopped state, in the sheet feeding control processing shown in FIG. 4, the microcomputer 32 shifts to step S4 through steps S1 and S3. In step S4, the microcomputer 32 outputs a drive instruction for driving the electric motors 4a and 5a, which drive the sheet feeding roller 4 and the conveying roller 5, to the motor drive circuits 33 and 34 to start driving the sheet feeding roller 4 and the conveying roller 5. Then, one recording sheet 2 is conveyed from the sheet feeding cassette 3 to the gate roller 10 through the conveying path 6.

When the recording sheet 2 is passed to the conveying roller 5, the microcomputer 32 stops driving the sheet feeding roller 4 (step S6). Subsequently, when the leading edge of the recording sheet 2 conveyed by the conveying roller 5 reaches the sheet passage sensor 31, and a sheet passage detection signal is inputted to the microcomputer 32 from the sheet passage sensor 31, the abnormality detection control processing shown in FIG. 12 is started.

Thereafter, the microcomputer 32 decrements the number of pieces of recording information and, then, stands by for elapse of a predetermined time until the next sheet feeding is started. When the predetermined time has elapsed, the microcomputer 32 returns to step S1 and, when recording information is present, repeats the sheet feeding operation.

On the other hand, when the leading edge of the recording sheet 2 reaches the sheet passage sensor 31 and execution of the abnormality detection control processing in FIG. 12 is started, the microcomputer 32 rotatory drives the gate roller 10 after an alignment time sufficient for the recording sheet 2 to come into an aligned state, in which the leading edge of the recording sheet 2 comes into contact with a pair of rollers of the stopped gate roller 10 entirely, elapses (step S22).

Consequently, the recording sheet 2 aligned in a conveying direction of the horizontal conveying section 11 is conveyed and passed to the conveyor belt 14 of the horizontal conveying section 11 by the gate controller 10. The leading edge of the recording sheet 2 reaches the optical sensor 22 of the recording medium abnormality detecting section 20. In the optical sensor 22, light emitted from the light-emitting element 22a when the recording sheet 2 is not present is reflected on the surface of the conveyor belt 14. The reflected light is made incident on the light-receiving element 22b. Consequently, a signal with a logical value “1” indicating a normal state is inputted to the microcomputer 32 from the light-receiving element 22b. When lift due to roll-up or bend does not occur at the leading edge of the recording sheet 2, as shown in FIG. 2A, light emitted from the light-emitting element 22a is reflected on the recording sheet 2 and the reflected light reaches the light-receiving element 22b. Consequently, a signal with a logical value “1” indicating the recording sheet 2 is normal is outputted to the microcomputer 32 from the light-receiving element 22b.

Therefore, in the processing in FIG. 12, when the recording sheet 2 is normal, a signal for continuing the logical value “1” is outputted from the optical sensor 22 before and after the recording sheet 2 reaches the optical sensor 22 of the recording medium abnormality detecting section 20. Thus, the microcomputer 32 shifts from step S24 to step S30. When the first predetermined time, in which the leading edge of the recording sheet 2 passes through the recording medium abnormality detecting section 20, elapses, the microcomputer 32 shifts to step S31. When the second predetermined time, in which the leading edge of the recording area of the recording sheet 2 reaches the recording area of the first recording head 17K of the recording head section 17, elapses, the microcomputer 32 shifts to step S32. When the third predetermined time, in which the trailing edge of the recording sheet 2 moves out of the gate roller 10, elapses after the recording control processing in FIG. 6 is started, the microcomputer 32 outputs a drive stop instruction for stopping the gate roller 10 to the motor drive circuit 36. The drive of the gate roller 10 is stopped (step S34).

On the other hand, in the recording control processing in FIG. 6, discharge control for ink droplets in the respective recording heads 17K to 17LM is performed on the basis of recording information inputted to the microcomputer 32 and conveying speed of the recording sheet 2. A recording image corresponding to the recording information is recorded on the recording sheet 2 in color and, then, discharged to the sheet discharge stacker 19.

However, lift affecting the recording head section 17 may occur at the leading edge of the recording sheet 2, which is conveyed by the gate roller 10, because of roll-up or bend. In such a case, when the leading edge of the recording sheet 2 reaches a position opposed to the optical sensor 22 of the recording medium abnormality detecting sensor 20, as shown in FIG. 2B, light emitted from the light-emitting element 22a and reflected at the leading edge of the recording sheet 2 is never made incident on the light-receiving element 22b. Thus, an abnormality signal with a logical value “0” indicating abnormality of the recording sheet 2 is outputted to the microcomputer 32 from the light-receiving element 22b.

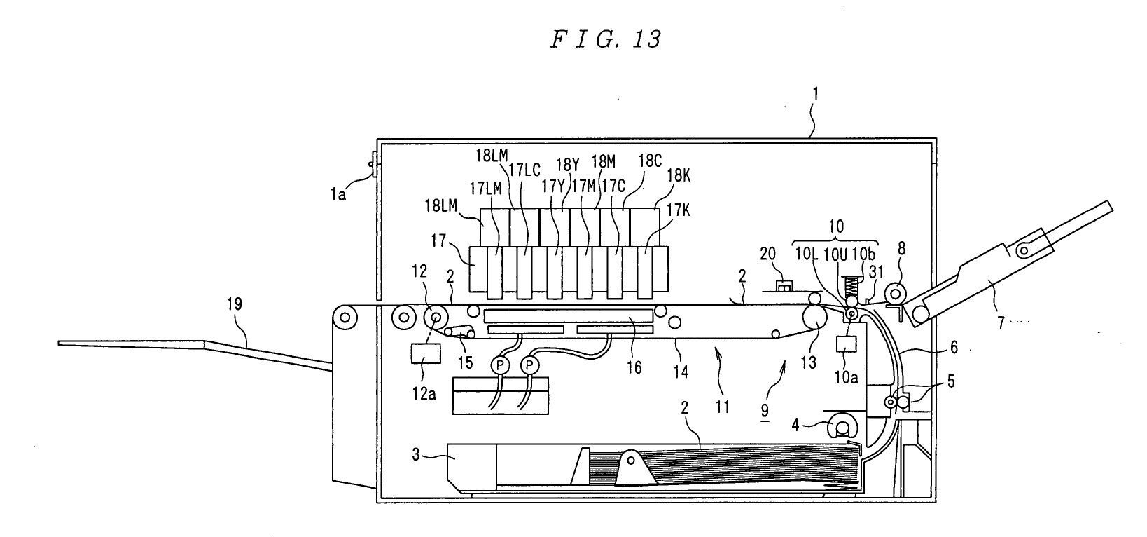

Therefore, in the abnormality detection processing in FIG. 12, the microcomputer 32 shifts from step S24 to step S25. A drive stop instruction for stopping drive of the gate roller 10 is outputted to the motor drive circuit 36 immediately, whereby drive of the gate roller 10 is stopped. Consequently, as shown in FIG. 13, conveyance of the recording sheet 2 is stopped in a state in which the recording sheet 2 is nipped by the gate roller 10. Subsequently, in step S26, a warning signal is outputted to the warning drive circuit 41 and a warning by sound and/or display is issued by the warning device 40 to notify a user of occurrence of an abnormal state.

In this case, since the drive roller 12 of the horizontal conveying section 11 continues the drive state, the conveying state is continued for the recording sheet 2 opposed to the recording head section 17. When the color printing by the recording heads 17K to 17LM is completed and the drive of the drive roller 12 and the air suction mechanism 16 of the horizontal conveying section 11 is stopped (steps S28 and S29)

In a state in which the recording sheet 2 having the abnormality is stopped, the leading edge of the recording sheet 2 never reaches the first recording head 17K of the recording head section 17 and is immediately behind the recording medium abnormality detecting section 20. In this state, there is no obstacle above the leading edge of the recording sheet 2 and the recording sheet 2 faces directly an upper surface section of the case body 1. Thus, if the upper surface section of the case body 1 is opened upward by a hinge 1a to open the upper surface of the case body 1, it is possible to visually recognize the leading edge of the recording sheet 2 from the opened surface. Therefore, it is possible to easily take out the recording sheet 2 having the abnormality to the outside by pinching and pulling out the leading edge of the recording sheet 2 with a hand in a state in which the upper roller 10U of the gate roller 10 is pulled up against a force of the coil spring 10b.

In this way, according to the second embodiment, again, the recording sheet 2, in which lift affecting the recording head section 17 occurs at the leading edge, is detected by the recording medium abnormality detecting section 20 provided near the gate roller 10. Drive of the gate roller 10 is stopped, whereby conveyance of the recording sheet 2 is stopped without being fed to the recording head section 17. Thus, it is possible to surely prevent the recording sheet 2 having the abnormality from being fed to the recording head section 17 and coming into contact with the recording head section 17 to cause not only stain on recording media, but also stain on and damage to an ink discharge surface of the recording head section 17, or discharge failure, sheet jam, and the like due to clogging of the recording head section 17.

When a sheet feed request for feeding a sheet from the sheet feeding cassette for hand supply 7 is present in recording information, the sheet feeding roller 8 of the sheet feeding cassette for hand supply 7 is rotatory driven, and the recording sheet 2 is sent to the sheet passage sensor 31. When a sheet passage detection signal is inputted to the microcomputer 32 from the sheet passage sensor 31, the abnormality detection control processing in FIG. 12 is started. When sheet feeding for one recording sheet 2 is completed, drive of the sheet feeding roller 8 is stopped. The microcomputer 32 is on standby until the next sheet feeding time comes after the number of pieces of recording information is decremented and, then, returns to step S1. When recording information is present, the microcomputer 32 repeats the processing.

Even in the state in which the recording sheet 2 is fed from the sheet feeding cassette for hand supply 7, when the abnormality detection control processing in FIG. 12 is executed, the gate roller 10 is rotatory driven to pass the recording sheet 2 to the conveyor belt 13. When the leading edge of the recording sheet 2 reaches the recording medium abnormality detecting section 20, presence or absence of abnormality of lift of the leading edge of the recording sheet 2 is detected and the same processing as at the time when the recording sheet 2 is fed from the sheet feeding cassette 3 is executed.

Note that, in the explanation of the second embodiment, conveyance of the recording sheet 2 is stopped by stopping drive of the gate roller 10 of the conveying mechanism 9. However, the invention is not limited to this. If printing of the preceding recording sheet is completed when conveyance of the recording sheet 2 having the abnormality is stopped, drive of the drive roller 12 of the horizontal conveying section 11 may be stopped simultaneously with drive of the gate roller 10. Moreover, if a length of a gap between the gate roller 10 and the recording head section 17 is larger than a length in the conveying direction of the recording sheet 1, and the trailing edge of the recording sheet 2 moves out of the gate roller 10 when conveyance of the recording sheet 2 is stopped, drive of only the drive roller 12 of the horizontal conveying section 11 may be stopped. In short, it is sufficient that conveyance of the recording sheet 2, in which abnormality of lift such as roll-up or bend occurs at the leading edge thereof, is stopped before reaching the recording head section 17.

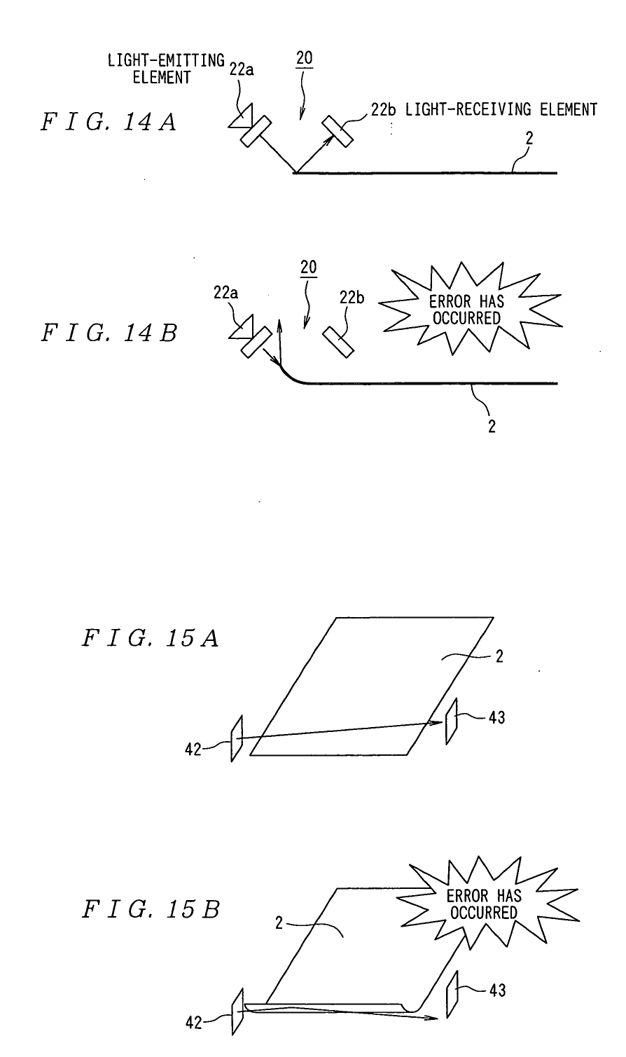

In the explanations of the first and the second embodiments, the reflection-type optical sensor, in which the light-emitting element 22a and the light-receiving element 22b are set in close contact with each other, is applied as the recording medium abnormality detecting section 20. However, the invention is not limited to this. As shown in FIGS. 14A and 14B, the light-emitting element 22a is arranged to be slanted, for example, 45 degrees and light reflected from the conveyor belt 13 or the recording sheet 2 is made incident on the light-receiving element 22b slanted 45 degrees. When abnormality due to lift does not occur at the leading edge of the recording sheet 2, as shown in FIG. 14A, light emitted from the light-emitting element 22 is reflected on the conveyor belt 13 or the recording sheet 2, and the reflected light is made incident on the light-receiving element 22b, and a signal with a logical value “1” is outputted from the light-receiving element 22b. When abnormality due to lift occurs at the leading edge of the recording sheet 2, as shown in FIG. 14B, light emitted from the light-emitting element 22a is reflected at the leading edge of the recording sheet 2, the reflected light is never made incident on the light-receiving element 22b, and an abnormal signal with a logical value “0” is outputted from the light-receiving element 22b.

As shown in FIGS. 15A and 15B, instead of the optical sensor 22, a laser beam source 42 emitting laser beams is fixedly arranged at one side edge of the conveying direction of the recording sheet 2 so as to emit laser beams in a direction slightly tilted from a direction orthogonal to the conveying direction. A light-receiving element 43 is arranged at the other side edge in the conveying direction of the recording sheet 2 that the laser beams reaches. When abnormality due to lift does not occur in the recording sheet 2, the laser beams from the laser beam source 42 are received by the light-receiving element 43 and a signal with a logical value “1” is outputted from the light-receiving element 43. When abnormality due to lift of the recording sheet 2 occurs, the laser beams emitted from the laser beam source 42 are blocked by the recording sheet 2 and an abnormal signal with a logical value “0” is outputted from the light-receiving element 43.

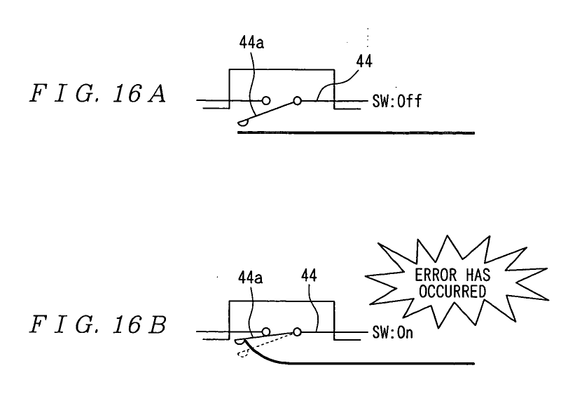

As shown in FIGS. 16A and 16B, instead of the optical sensor 22, a micro-switch 44 is disposed to be opposed to the recording sheet 2 from the above. When abnormality due to lift does not occur at the leading edge of the recording sheet 2, the leading edge of the recording sheet 2 never comes into contact with a movable contact point 44a and the switch maintains an OFF state to output a signal with a logical value “1” indicating that a recording medium is normal. When abnormality due to lift occurs at the leading edge of the recording sheet 2, the leading edge of the recording sheet 2 comes into contact with the movable contact point 44a and the switch comes into an ON state to output an abnormal signal with a logical value “0” indicating that a recording medium is abnormal.

In the explanations of the first and the second embodiments, the air suction mechanism 16 is provided between the drive roller 12 and the driven roller 13 in the horizontal conveying section 11 such that the recording sheet 2 placed on the conveyor belt 14 is attracted by the air sucked by the air suction mechanism 16. However, the invention is not limited to this. The image forming apparatus may be constituted as described below. A charger for attraction, which charges the recording sheet 2 with static electricity, is disposed between the gate roller 10 and the driven roller 13 instead of the air suction mechanism 16. The recording sheet 2 is charged with static electricity by the charger for attraction, whereby the recording sheet 2 is electrostatically attracted to the conveyor belt 14.

In the explanations of the first and the second embodiments, the recording sheet 2 is applied as a recording medium. However, the present invention is not limited to this. It is possible to apply any other recording medium.

In the explanations of the first and the second embodiments, the invention is applied to the image forming apparatus of the ink jet printing method that discharges ink droplets from the recording heads 17K to 17LM. However, the invention is not limited to this. The number of recording heads may be set to any number. In addition, it is possible to apply the invention when a recording medium is peeled from a conveyor belt in other image forming apparatuses such as a laser printer, a copying machine, and a facsimile.

1. An image forming apparatus that conveys a recording medium, which is fed from a sheet feeding section, to an image recording section with a conveying section to form an image on the recording medium and, then, carries the recording medium out, comprising:
a recording medium abnormality detecting section that detects abnormality of the recording medium, which affects the image recording section, between the sheet feeding section and the image recording section; and
an abnormal discharge section that discharges the recording medium through an abnormal time conveying path different from a normal conveying path when the recording medium abnormality detecting section detects abnormality of the recording medium.

2. The image forming apparatus according to claim 1, wherein the abnormal discharge section comprises a path selecting section that, when the recording medium abnormality detecting section does not detect abnormality of the recording medium, transfers the recording medium to the normal conveying path and, when the recording medium abnormality detecting section detects abnormality of the recording medium, transfers the recording medium to the abnormal time conveying path.

3. The image forming apparatus according to claim 2, wherein
the path selecting section comprises:
a spring-up mechanism that springs up a leading edge of the recording medium from the normal conveying path when the recording medium abnormality detecting section detects abnormality of the recording medium; and
a scoop-up mechanism that scoops up a leading edge of the recording medium scooped up by the scoop-up mechanism and guides the recording medium to the abnormal time conveying path.

4. The image forming apparatus according to claim 2, wherein
the path selecting section comprises:
a drive roller that is fixedly arranged on a side to which the recording medium is fed;
a movable roller that is movable between a normal position continuously connected to the normal conveying path on a side to which the recording medium is discharged and an abnormal time position continuously connected to the abnormal time conveying path;
a conveyor belt stretched and suspended between both the rollers; and
a roller moving mechanism that moves the movable roller between the normal position and the abnormal time position.

5. The image forming apparatus according to claim 1, wherein the abnormal time conveying path has a recording medium housing section exposed to the outside that houses the recording medium fed from the path selecting section.

6. The image forming apparatus according to claim 1, wherein the abnormal time conveying path has a recording medium housing section formed therein that houses the recording medium fed from the path selecting section.

7. The image forming apparatus according to claim 1, wherein the abnormal discharge section comprises a warning device that issues a warning when the recording medium abnormality detecting section detects abnormality of the recording medium.

8. An image forming apparatus that conveys a recording medium, which is fed from a sheet feeding section, to an image recording section with a conveying section to form an image on the recording medium and, then, carries the recording medium out, comprising:
a recording medium abnormality detecting section that detects abnormality of the recording medium, which affects the image recording section, between the sheet feeding section and the image recording section; and
an abnormal stop section that stops the recording medium before the image recording section when the recording medium abnormality detecting section detects abnormality of the recording medium.

9. The image forming apparatus according to claim 8, wherein the abnormal stop section comprises a conveyance stop section that stops the conveying section when the recording medium abnormality detecting section detects abnormality of the recording medium.

10. The image forming apparatus according to claim 8, wherein the abnormal stop section comprises a warning device that issues a warning when the recording medium abnormality detecting section detects abnormality of the recording medium.

11. The image forming apparatus according to claim 1, wherein the recording medium abnormality detecting section comprises an optical sensor that detects lift of a recording medium from a conveyance surface.

12. The image forming apparatus according to claim 11, wherein the optical sensor comprises a laser beam sensor.

13. The image forming apparatus according to claim 1, wherein the recording medium abnormality detecting section comprises a contact-type sensor that detects lift of the recording medium from a conveyance surface.

14. The image forming apparatus according to claim 8, wherein the recording medium abnormality detecting section comprises an optical sensor that detects lift of the recording medium from the conveyance surface.

15. The image forming apparatus according to claim 14, wherein the optical sensor comprises a laser beam sensor.

16. The image forming apparatus according to claim 8, wherein the recording medium abnormality detecting section comprises a contact-type sensor that detects lift of the recording medium from the conveyance surface.
